(19) United States
(12) Patent Application Publication
(10) Pub. No.: US 2020/0340291 A9
(43) Pub. Date: Oct. 29, 2020

(54) INTERNAL INTEGRAL REINFORCEMENT STRUT AND HINGE FASTENING BACKER PLATE FOR OVERHEAD SECTIONAL DOORS

(71) Applicant: Peter F. Schank, Holmen, WI (US)

(72) Inventor: Peter F. Schank, Holmen, WI (US)

(21) Appl. No.: 16/023,350

(22) Filed: Jun. 29, 2018

Related U.S. Application Data
(60) Provisional application No. 62/604,293, filed on Jun. 30, 2017.
(60) Provisional application No. 62/605,122, filed on Aug. 2, 2017.

(51) Int. Cl. E06B 3/48; E06B 3/70

(52) U.S. Cl. CPC E06B 3/485; E06B 3/7015; E06B 2003/7049; E06B 2003/7044; E06B 2003/7051; E06B 3/70

(57) ABSTRACT

A panel for an overhead sectional door includes an exterior skin on an exterior-facing side of the panel and an interior skin on an interior-facing side of the panel that define a plenum. An insulating material is disposed in the plenum. An upper backer strut is disposed in the plenum proximate a top leading edge of the interior skin and extends across a full length of the panel. A lower backer strut is disposed in the plenum proximate a bottom leading edge of the panel and extends across a full length of the panel. The upper backer strut and the lower backer strut each include first and second strut legs extending into the plenum. The first and second strut legs are spaced from the exterior skin. Hardware is attached to the panel by fastening the hardware to one of the upper backer strut and the lower backer strut.

### CROSS-REFERENCE TO RELATED APPLICATION

This application claims priority to U.S. Provisional Application No. 62/604,293 filed Jun. 30, 2017, and entitled “HIDDEN PERFORMANCE INTERNAL INTEGRAL REINFORCEMENT STRUT AND HINGE FASTENING BACKER PLATE FOR OVERHEAD GARAGE DOORS,” and to U.S. Provisional Application No. 62/605,122, filed Aug. 2, 2017, and entitled “HPI DOOR (HIDDEN PERFORMANCE INSIDE) HIDDEN PERFORMANCE INTERNAL INTEGRAL REINFORCEMENT STRUT AND HINGE FASTENING BACKER PLATE FOR OVERHEAD GARAGE DOORS,” the disclosures of which are hereby incorporated in their entirety.

### BACKGROUND

This disclosure relates generally to overhead sectional doors. More particularly, this disclosure relates to internal reinforcement and hinge fastening for overhead sectional doors.

Overhead sectional doors, also referred to as vehicular doors, are formed from individual panel sections that are joined together by hinges. Overhead sectional doors also include top and bottom roller fixtures and provide a lift cable anchor point connection at the bottom of the lowest leading edge of the bottom panel. Overhead sectional doors can also be required to support the connection of an automatic operator to open and close the door.

The hardware is attached to the interior side of each panel. The hardware can be attached to vertical stiles that are disposed vertically in or on each panel or to flat backer plates that are disposed within the panel adjacent an interior side of an interior-facing skin. The vertical stiles or backer plates are spaced laterally across the width of the panel and the hardware is attached to the stiles or backer plates by fasteners. Attaching hardware to vertical stiles or backer plates limits the area available for attachment to areas where the vertical stiles or backer plates are already present. Where the vertical stiles are embedded in the panel between an exterior-facing skin and the interior-facing skin, the exact locations of the stiles may not be apparent to an installer. This can lead to fastener holes being drilled through the interior-facing panel in locations that are not suitable for hardware installation, causing the hardware to come apart from the door panel and create a potential overhead structural panel failure, and can create an aesthetically unappealing look on the interior-facing skin due to the extraneous holes.

In addition, the individual panels require additional structural reinforcement to ensure that the overhead door has sufficient structural integrity to support itself when the overhead sectional door is in the overhead (open) position and to meet wind loading requirements. The number and size of the additional reinforcing struts increases as the wind load requirements increase. Reinforcement struts are attached to the interior side of the panel to provide the necessary reinforcement. These reinforcement struts are typically installed in the field, which can lead to confusion regarding the required strut quantity, strut size, and designed placement locations for each strut. The struts can also create climbing hazards, create hanging hazards, limit the hardware that can be attached to the door, and limit window placement. The struts are also aesthetically unappealing. The reinforcing struts are shipped to the installer separate from the door panel, which leaves the door panel susceptible to kinking, bending, and other structural failure damage during each phase of manufacturing, shipping, and handling of the door panels before and during installation of each overhead door panel.

### SUMMARY

According to one aspect of the disclosure, a panel for an overhead door includes an exterior skin and an interior skin spaced from the exterior skin. The interior skin has a vertical portion, a top portion extending from a top leading edge of the vertical portion, and a bottom portion extending from a bottom leading edge of the vertical portion. The interior skin is spaced from the exterior skin to define a plenum therebetween. An upper backer strut is disposed within the plenum proximate the top leading edge and extends across a length of the panel. The upper backer strut includes an upper strut body at least partially abutting a side of the vertical portion of the interior skin facing the plenum; a first upper strut leg extending from the upper strut body and having a first upper distal end spaced from the exterior skin; and a second upper strut leg extending from the upper strut body and having a second upper distal end spaced from the exterior skin. A lower backer strut is disposed within the plenum proximate the bottom leading edge and extends across the length of the panel. The lower backer strut includes a lower strut body at least partially abutting the side of the vertical portion of the interior skin facing the plenum; a first lower strut leg extending from the lower strut body and having a first lower distal end spaced from the exterior skin; and a second lower strut leg extending from the lower strut body and having a second lower distal end spaced from the exterior skin.

According to another aspect of the disclosure, an overhead sectional door includes a plurality of panels. Each one of the plurality of panels includes an exterior skin and an interior skin spaced from the exterior skin. The interior skin has a vertical portion, a top portion extending from a top leading edge of the vertical portion, and a bottom portion extending from a bottom leading edge of the vertical portion. The interior skin is spaced from the exterior skin to define a plenum therebetween. An upper backer strut is disposed within the plenum proximate the top leading edge and extends across a length of the panel. The upper backer strut includes an upper strut body at least partially abutting a side of the vertical portion of the interior skin facing the plenum; a first upper strut leg extending from the upper strut body and having a first upper distal end spaced from the exterior skin; and a second upper strut leg extending from the upper strut body and having a second upper distal end spaced from the exterior skin. A lower backer strut is disposed within the plenum proximate the bottom leading edge and extends across the length of the panel. The lower backer strut includes a lower strut body at least partially abutting the side of the vertical portion of the interior skin facing the plenum; a first lower strut leg extending from the lower strut body and having a first lower distal end spaced from the exterior skin; and a second lower strut leg extending from the lower strut body and having a second lower distal end spaced from the exterior skin. A plurality of hinges connect adjacent ones of the plurality of panels. The plurality of hinges are disposed on the vertical portion of the interior skin and are connected to the upper backer strut and the lower backer strut.

According to yet another aspect of the disclosure, a reinforcing and hardware attachment assembly for an overhead sectional door panel includes an upper backer strut disposed within the overhead sectional door panel proximate a top leading edge on an interior side of a skin of the overhead sectional door panel, and a lower backer strut disposed within the plenum proximate a bottom leading edge on the interior side of the skin of the overhead sectional door panel. The upper backer strut includes an upper strut body abutting the interior side of the overhead sectional door panel; a first upper strut leg extending from the upper strut body and having a first upper distal end spaced from an exterior side of the overhead sectional door panel; and a second upper strut leg extending from the upper strut body and having a second upper distal end spaced from the exterior side of the overhead sectional door panel. The lower backer strut includes a lower strut body abutting the interior side of the overhead sectional door panel; a first lower strut leg extending from the lower strut body and having a first lower distal end spaced from the exterior side of the overhead sectional door panel; and a second lower strut leg extending from the lower strut body and having a second lower distal end spaced from the exterior side of the overhead sectional door panel. The upper backer strut and the lower backer strut extend across a full length of the overhead sectional door panel. The upper strut body is configured to receive one or more fasteners extending through the interior side of the overhead sectional door panel and the lower strut body is configured to receive one or more fasteners extending through the skin of the body.

### BRIEF DESCRIPTION OF THE DRAWINGS

FIG. 1A is a perspective view of an overhead door assembly.

FIG. 1B is a rear elevation view showing the interface between adjacent panels of the overhead door assembly of FIG. 1A.

FIG. 1C is a cross-sectional view showing a connection between adjacent panels taken along line C-C in FIG. 1B.

FIG. 2 is a cross-sectional, perspective view of a panel.

FIG. 3 is a cross-sectional, perspective view of a panel.

FIG. 4 is a cross-sectional, perspective view of a panel.

### DETAILED DESCRIPTION

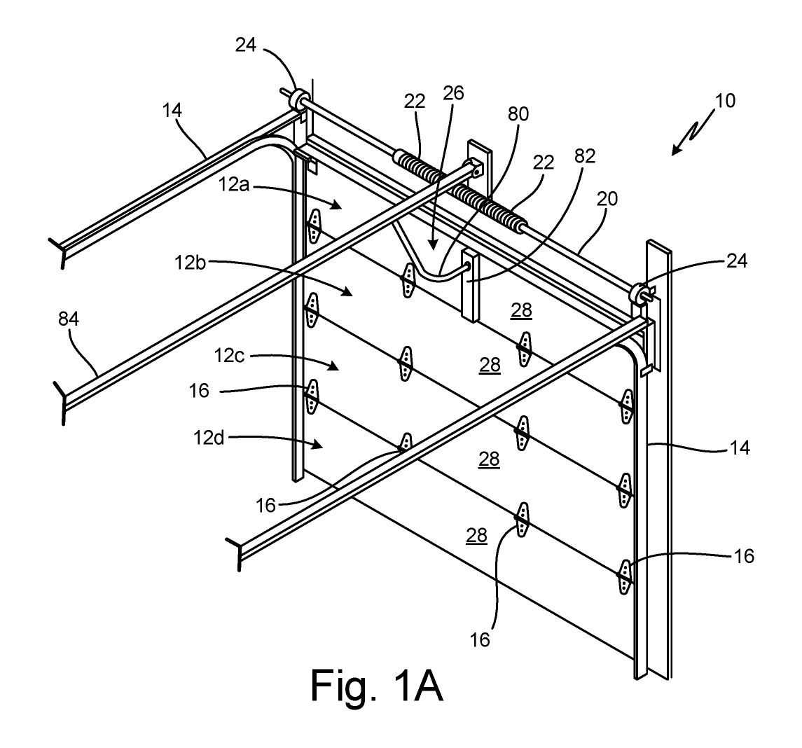

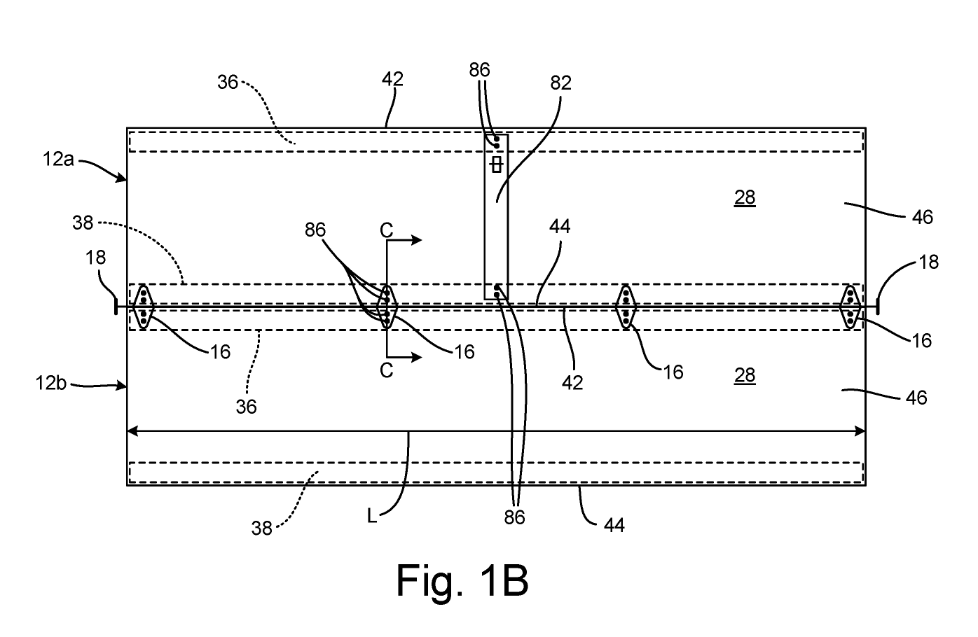

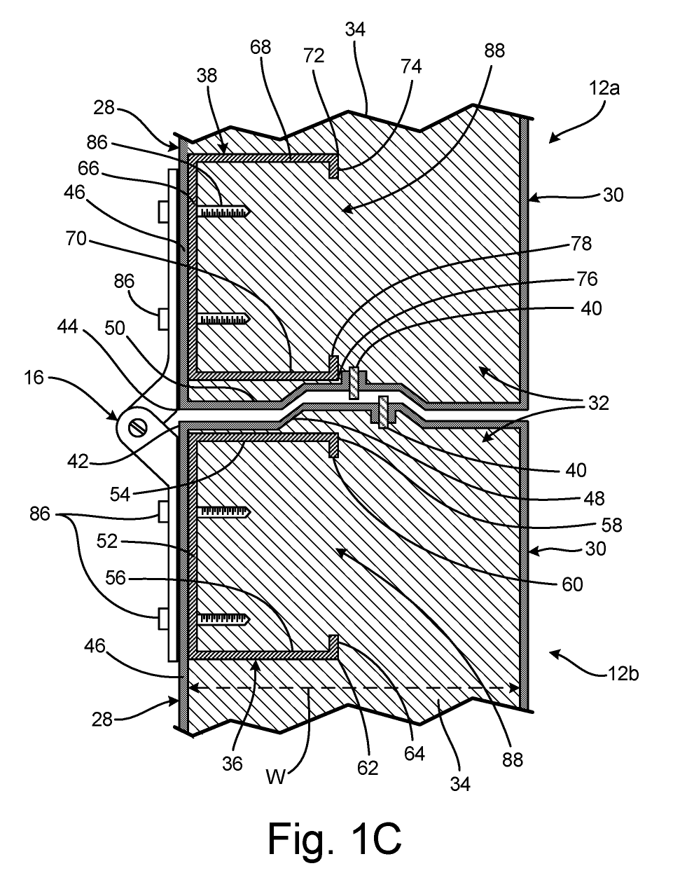

FIG. 1A is a perspective view of overhead door 10. FIG. 1B is a rear elevation view of panel 12a and panel 12b of overhead door 10 showing an interface between panel 12a and panel 12b. FIG. 1C is a cross-sectional view of overhead door 10 taken along line C-C in FIG. 1B. FIGS. 1A-1C will be discussed together. Overhead door 10 includes panels 12a-12d (collectively herein “panel 12”), tracks 14, hinges 16, rollers 18, torsion bar 20, torsion spring 22, cable drums 24, and operator 26. Each panel 12a-12d includes interior skin 28, exterior skin 30, plenum 32, insulating material 34, upper backer strut 36, lower backer strut 38, thermal break 40, top leading edge 42, and bottom leading edge 44. Interior skin 28 includes vertical portion 46, upper edge 48, and lower edge 50. Upper backer strut 36 includes upper strut body 52, first upper strut leg 54, and second upper strut leg 56. First upper strut leg 54 includes first upper distal end 58, which includes first upper flange 60. Second upper strut leg 56 includes second upper distal end 62, which includes second upper flange 64. Lower backer strut 38 includes lower strut body 66, first lower strut leg 68, and second lower strut leg 70. First lower strut leg 68 includes first lower distal end 72, which includes first lower flange 74. Second lower strut leg 70 includes second lower distal end 76, which includes second lower flange 78. Operator 26 includes operator arm 80, operator bracket 82, and operator track 84. Overhead door 10 is a sectional overhead door of the type commonly employed in residential garages. It is understood, however, that overhead door 10 can be utilized for residential, commercial, and other desired movable barrier applications.

Panels 12a-12d are stacked vertically within the door opening covered by overhead door 10. Adjacent ones of panels 12a-12d are connected by hinges 16. Panel 12a is the top panel of overhead door 10, panels 12b-12c are the intermediate panels of overhead door 10, and panel 12d is the bottom panel of overhead door 10. Hinges 16 are mounted on interior skins 28 by fasteners 86. Rollers 18 extend laterally from hinges 16 mounted on the edges of panels 12. Rollers 18 extend into and are guided by tracks 14.

Tracks 14 extend both vertically and horizontally to guide rollers 18, and thus overhead door 10. The vertical portion of each track 14 extends from the garage floor and is attached to a frame that defines the door opening. The horizontal portion of each track 14 extends from the vertical portion and is supported by a support structure (not shown) that is typically attached to the ceiling of the garage.

Torsion bar 20 extends laterally above the door opening. Torsion spring 22 is disposed on torsion bar 20 and assists in the lifting and lowering of overhead door 10. Cable drums 24 are mounted at the ends of torsion bar 20 and are configured to rotate with torsion bar 20. A cable (not shown) extends from each cable drum 24 and is connected to panel 12d. Operator 26 mechanically lifts and lowers overhead door 10. Operator bracket 82 is mounted on panel 12a. Operator arm 80 is attached to operator bracket 82 and is pulled along operator track 84 by a chain (not shown) extending from an operator mechanism (not shown).

Interior skin 28 is disposed on an interior-facing side of panel 12, and exterior skin 30 is disposed on an exterior-facing side of panel 12. Interior skin 28 and exterior skin 30 define plenum 32 therebetween. Insulating material 34 is disposed within plenum 32. Insulating material 34 can be any suitable material for thermally insulating panel 12, such as liquid urethane or a polystyrene sheet. In some examples, interior skin 28 and exterior skin 30 can be bonded to insulating material 34 by an adhesive. While panels 12a-12d are described as including insulating material 34, it is understood that plenum 32 can remain as a void that is free of any insulating material 34.

Top leading edge 42 is disposed at an intersection of vertical portion 46 and upper edge 48 of interior skin 28. Upper edge 48 extends inwards from top leading edge 42 to thermal break 40. Bottom leading edge 44 is disposed at an intersection of vertical portion 46 and lower edge 50. Similar to upper edge 48, lower edge 50 extends from vertical portion 46 to thermal break 40. Each thermal break 40 is disposed at an interface between interior skin 28 and exterior skin 30. Thermal break 40 is a material having low thermal conductivity, such as an elastomer. Thermal break 40 provides a barrier between interior skin 28 and exterior skin 30, which are typically formed from a thermally conductive material, such as a metal, to prevent thermal conduction through panel 12. For example, thermal break 40 can be made of ethylene propylene diene monomer (EPDM) rubber, but it is understood that any desired material having low thermal conductivity can be utilized.

Upper backer strut 36 is disposed within plenum 32 adjacent interior skin 28 and proximate upper edge 48 of interior skin 28. Upper backer strut 36 is continuous and extends a full length L of panel 12 and is configured to provide both attachment points for all hinges 16 and structural rigidity to panel 12. Upper strut body 52 abuts the interior side of vertical portion 46 of interior skin 28. First upper strut leg 54 extends from the top of upper strut body 52 to first upper distal end 58. First upper flange 60 extends from first upper distal end 58. Second upper strut leg 56 extends from the bottom of upper strut body 52 to second upper distal end 62. Second upper flange 64 extends from second upper distal end 62. First upper flange 60 and second upper flange 64 provide additional rigidity to upper backer strut 36 to prevent deflection of panel 12. Both first upper strut leg 54 and second upper strut leg 56 extend partially across the width W of plenum 32, such that both first upper distal end 58 and second upper distal end 62 are spaced from exterior skin 30. As such, neither first upper strut leg 54 nor second upper strut leg 56 contact exterior skin 30, thereby preventing upper backer strut 36 from providing a thermal conduction path through panel 12 between exterior skin 30 and interior skin 28. As shown, first upper strut leg 54 extends to but not past thermal break 40.

Gap 88 is disposed between first upper flange 60 and second upper flange 64.

Gap 88 provides an opening for insulating material 34 to enter the space within upper backer strut 36 between first upper strut leg 54 and second upper strut leg 56. In some examples, during manufacturing, insulating material 34 is applied to panel 12 as a liquid, such as liquid urethane, that is then cured-in-place. Gap 88 allows the liquid insulating material to flow into and around upper backer strut 36, such that insulating material 34 fills plenum 32 without leaving undesired voids within plenum 32.

Similar to upper backer strut 36, lower backer strut 38 is disposed within plenum 32 adjacent interior skin 28, but lower backer strut 38 is disposed proximate lower edge 50 of interior skin 28. Lower backer strut 38 is located proximate bottom leading edge 44 of panel 12. Lower backer strut 38 is continuous and extends a full length L of panel 12. Lower backer strut 38 provides both attachment points for all hinges 16 and structural rigidity to panel 12. Lower strut body 66 abuts the interior side of vertical portion 46 of interior skin 28. First lower strut leg 68 extends from the top of lower strut body 66 to first lower distal end 72. First lower flange 74 extends from first lower distal end 72. Second lower strut leg 70 extends from the bottom of lower strut body 66 into plenum 32. First lower flange 74 and second lower flange 78 provide additional rigidity to lower backer strut 38 to prevent deflection of panel 12. Both first lower strut leg 68 and second lower strut leg 70 extend partially across the width W of plenum 32, such that both first lower distal end 72 and second lower distal end 76 are spaced from exterior skin 30. As such, neither first lower strut leg 68 nor second lower strut leg 70 contact exterior skin 30, thereby preventing lower backer strut 38 from providing a thermal conduction path through panel 12 between exterior skin 30 and interior skin 28. As shown, second lower strut leg 70 extends to but not past thermal break 40.

Gap 88 is disposed between first lower flange 74 and second lower flange 78. Gap 88 provides an opening for insulating material 34 to enter the space within lower backer strut 38 between first lower strut leg 68 and second lower strut leg 70, which allows liquid insulating material to flow into and around lower backer strut 38 during manufacturing. As such, gap 88 ensures that insulating material 34 fills plenum 32 without leaving undesired voids within plenum 32.

Both upper backer strut 36 and lower backer strut 38 are continuous and extend across a full length L of panel 12. Hinges 16 are spaced laterally across the width of panel 12 and are secured to each panel 12 by fasteners 86. Fasteners 86 extend through hinge plates of hinges 16, through interior skin 28, and through upper backer strut 36 or lower backer strut 38. Upper backer strut 36 and lower backer strut 38 provide attachment points for all hinges 16 attached to the panel 12. Because both upper backer strut 36 and lower backer strut 38 extend across the full length L of panel 12, hinges 16 can be attached at any desired location along the full length L of panel 12, which ensures that hinges 16 can be connected at the most appropriate locations along the length L of panel 12.

As shown in FIG. 1B, operator bracket 82 is also attached to both upper backer strut 36 and lower backer strut 38 of panel 12a by fasteners 86. During installation, operator bracket 82 should be aligned with operator track 84 to ensure that torque is not transmitted to panel 12a through operator arm 80 and operator bracket 82. Both upper backer strut 36 and lower backer strut 38 extending the full length L of panel 12a allows operator bracket 82 to be secured at the appropriate location along the length L of panel 12a.

Upper backer strut 36 and lower backer strut 38 provide strength and stiffness to panel 12, particularly to resist forces perpendicular to exterior skin 30, such as wind forces. The increased strength provided by upper backer strut 36 and lower backer strut 38 prevents panel deflection due to those perpendicular forces, and also resists twisting of panels 12. Embedding upper backer strut 36 and lower backer strut 38 within panel 12 allows upper backer strut 36 and lower backer strut 38 to be located proximate top leading edge 42 and bottom leading edge 44, respectively. Top leading edge 42 and bottom leading edge 44 experience significant stresses relative to the remainder of panel 12 as overhead door 10 is raised and lowered during operation. As such, locating upper backer strut 36 proximate top leading edge 42 provides additional strength to panels 12 at a highly stressed location. Similarly, locating lower backer strut 38 at bottom leading edge 44 provides additional strength to panels 12 at another highly stressed location.

Panels 12 can be assembled individually or assembled continuously. When assembled individually, exterior skin 30 and interior skin 28 are formed and cut to length. Upper backer strut 36 and lower backer strut 38 are also formed and cut to length. Insulating material 34 is typically applied as a solid foam product within plenum 32. Insulating material 34 can be inserted into plenum 32 before, after, or simultaneously with upper backer strut 36 and lower backer strut 38. Where upper backer strut 36 and lower backer strut 38 are positioned on interior skin 28 prior to installing insulating material 34, both upper backer strut 36 and lower backer strut 38 can be secured to interior skin 28 by adhesive or by punch-locking to interior skin 28. Insulating material 34 is installed, and exterior skin 30 can be secured to insulating material 34 with an adhesive.

When assembled continuously, interior skin 28 and exterior skin 30 are pulled from stock rolls of sheet material, such as metal. Upper backer strut 36 and lower backer strut 38 can also be pulled form stock rolls of sheet material and placed in position. Interior skin 28 is fed onto an assembly line, and upper backer strut 36 and lower backer strut 38 are positioned on interior skin 28. Upper backer strut 36 and lower backer strut 38 are secured to interior skin 28 by an adhesive or by punch-locking to interior skin 28. Insulating material 34 is applied, either as a solid or liquid foam, and then exterior skin 30 is placed. Where insulating material 34 is applied as a liquid foam product, insulating material 34 is cured and panel 12 is then cut to length.

Upper backer strut 36 and lower backer strut 38 provide significant advantages. Upper backer strut 36 and lower backer strut 38 extend across a full length L of panels 12, providing attachment points for all hardware, including hinges 16 and operator bracket 82. The installer can attach hinges 16 and operator bracket 82 at any desired location along length L. The installer can locate hinges 16 and operator bracket 82 at any desired location along the length of panels 12, eliminating the need to drill additional holes and move the hardware if the installer initially locates hinges 16 or operator bracket 82 at a location without additional support. As such, upper backer strut 36 and lower backer strut 38 further ensure that interior skin 28 has an aesthetically-pleasing appearance by eliminating the possibility of holes being drilled through interior skin 28 at undesired or unsuitable locations. First upper strut leg 54, second upper strut leg 56, first lower strut leg 68, and second lower strut leg 70 are all spaced from exterior skin 30. As such, neither upper backer strut 36 nor lower backer strut 38 provide a conduction path through panel 12, thereby preserving the R-value of panels 12.

In addition, upper backer strut 36 and lower backer strut 38 provide increased structural integrity to panels 12, preventing panel deflection due to wind loading and other forces. Upper backer strut 36 and lower backer strut 38 are located proximate top leading edge 42 and bottom leading edge 44, respectively. Previously, reinforcing struts had to be offset from the top leading edge 42 and the bottom leading edge 44 to provide space for hardware attachment. Spacing reinforcing struts from top leading edge 42 and bottom leading edge 44 required more robust struts to provide the necessary support at those highly stressed locations. The increased structural integrity also protects panels 12 during manufacturing, storage, and transit. Upper backer strut 36 and lower backer strut 38 resist twisting of panels 12, which prevents unintended bending of panels 12 during transit, which can break glass windows embedded in panels 12 or can cause panels 12 to become warped and unusable.

Moreover, upper backer strut 36 and lower backer strut 38 are embedded in panel 12, which eliminates the reinforcing struts that project outwardly from interior skin 28. Eliminating the projecting struts provides a smooth, aesthetically pleasing look for interior skin 28. Eliminating the projecting struts also simplifies manufacturing and installation of overhead door 10, as upper backer strut 36 and lower backer strut 38 are embedded in panels 12 during manufacturing. The exterior reinforcing struts are typically shipped separate from the panels and installed at the job site. Upper backer strut 36 and lower backer strut 38 thereby eliminate the need for those loose struts, which reduces the number of loose parts, reduces the labor required to install overhead door 10, reduces installation time, and increases installation efficiency.

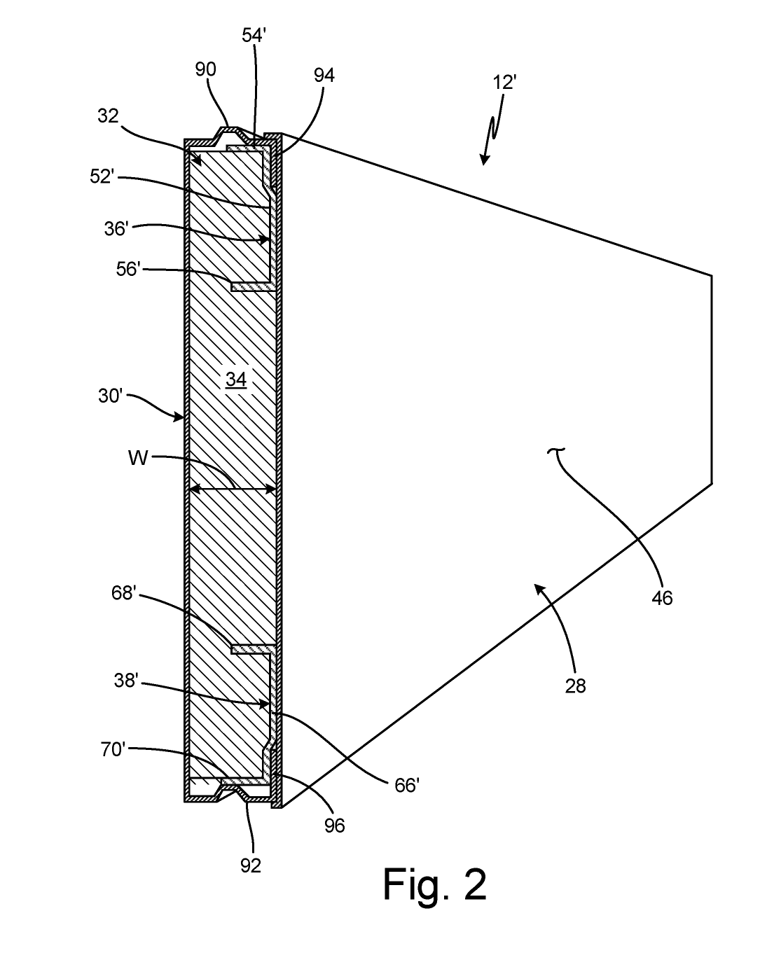

FIG. 2 is a cross-sectional, perspective view of panel 12′. Panel 12′ includes interior skin 28′, exterior skin 30′, plenum 32, insulating material 34, upper backer strut 36′, and lower backer strut 38′. Interior skin 28′ includes vertical portion 46. Exterior skin 30′ includes top portion 90, bottom portion 92, upper flange 94, and lower flange 96. Upper backer strut 36′ includes upper strut body 52′, first upper strut leg 54′, and second upper strut leg 56′. Lower backer strut 38′ includes lower strut body 66′, first lower strut leg 68′, and second lower strut leg 70′.

Panel 12′ is a panel for an overhead sectional door, such as overhead door 10 (FIG. 1A). Interior skin 28′ is disposed on an interior-facing side of panel 12′ and exterior skin 30′ is disposed on an exterior-facing side of panel 12′. Interior skin 28′ and exterior skin 30′ define plenum 32. Top portion 90 of exterior skin 30′ defines an uppermost extent of panel 12′, and top portion 90 includes the tongue of the tongue-and-groove connection between adjacent panels 12′. Upper flange 94 extend downward from top portion 90 and is disposed adjacent interior skin 28′. Bottom portion 92 of exterior skin 30′ defines a lowermost extent of panel 12′, and bottom portion 92 includes the groove of the tongue-and-groove connection. Lower flange 96 extends upward from bottom portion 92 and is disposed adjacent interior skin 28′.

Insulating material 34 is disposed within plenum 32 and configured to thermally insulate panel 12′. Relief cuts extend into insulating material 34 and are configured to receive second upper strut leg 56′ and first lower strut leg 68′. While insulating material 34 is described as including relief cuts, it is understood that insulating material 34 can be applied to panel 12′ as a liquid foam and then cured-in-place.

Upper backer strut 36′ is disposed within plenum 32 adjacent interior skin 28′ and proximate top leading edge 42 of panel 12′. Upper backer strut 36′ is a continuous strip that extends a full length L of panel 12′. Upper backer strut 36′ provides attachment points for all hardware, such as hinges 16 (FIGS. 1A-1C) and operator bracket 82 (FIGS. 1A-1B), and provides structural rigidity to panel 12′. A portion of upper strut body 52′ abuts the interior side of interior skin 28′ and another portion of upper strut body 52′ abuts the interior side of upper flange 94. First upper strut leg 54′ extends from the top of upper strut body 52′ into plenum 32. Second upper strut leg 56′ extends from the bottom of upper strut body 52′ into plenum 32 and is disposed in a relief cut in insulating material 34. Both first upper strut leg 54′ and second upper strut leg 56′ extend partially across the width W of plenum 32.

Similar to upper backer strut 36′, lower backer strut 38′ is disposed within plenum 32 adjacent interior skin 28′, but lower backer strut 38′ is disposed proximate bottom leading edge 44 of panel 12′. Lower backer strut 38′ is a continuous strip that extends a full length L of panel 12′ and provides attachment points for all hardware, such as hinges 16 and operator bracket 82, and structural rigidity to panel 12′. A portion of lower strut body 66′ abuts the interior side of interior skin 28′ and another portion of lower strut body 66′ abuts the interior side of lower flange 96. First lower strut leg 68′ extends from the top of lower strut body 66′ into plenum 32 and is disposed in a relief cut in insulating material 34. Second lower strut leg 70′ extends from the bottom of lower strut body 66′ into plenum 32. Second lower strut leg 70′ extends along and is disposed adjacent to bottom portion 92 of exterior skin 30′. Both first lower strut leg 68′ and second lower strut leg 70′ extend partially across the width W of plenum 32.

Both upper backer strut 36′ and lower backer strut 38′ are continuous and extend across the full length L of panel 12′. The hardware is attached to panel 12′ by fasteners extending through the hardware, through vertical portion 46 of interior skin 28′, and into one of upper backer strut 36′ and lower backer strut 38′. In some cases, some or all of the fasteners also extend through one of upper flange 94 and lower flange 96. Extending the fasteners through one of upper flange 94 and lower flange 96 secures interior skin 28′ to exterior skin 30′.

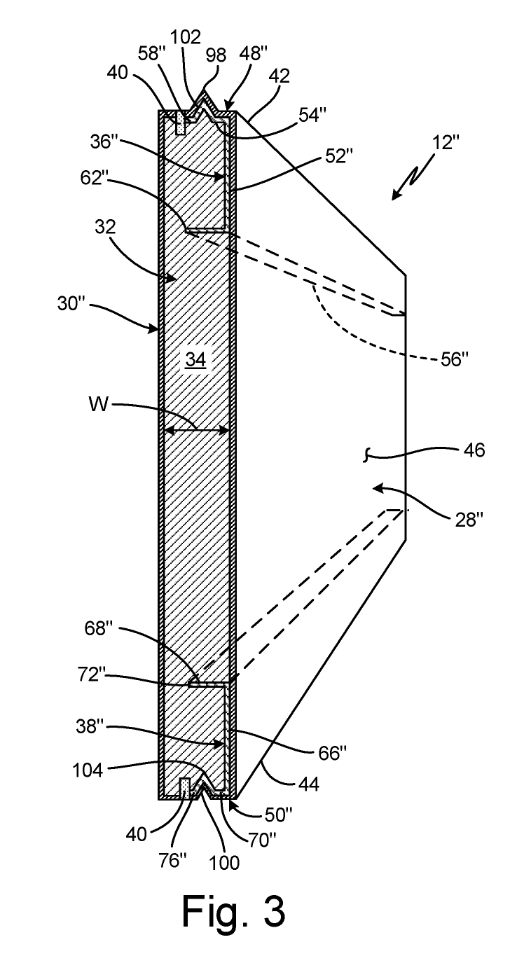

FIG. 3 is a cross-sectional, perspective view of panel 12″. Panel 12″ includes interior skin 28″, exterior skin 30″, plenum 32, insulating material 34, upper backer strut 36″, lower backer strut 38″, thermal break 40, top leading edge 42, and bottom leading edge 44. Interior skin 28″ includes vertical portion 46, upper edge 48″, and lower edge 50″. Upper edge 48″ includes tongue 98, and lower edge 50″ includes groove 100. Upper backer strut 36″ includes upper strut body 52″, first upper strut leg 54″, and second upper strut leg 56″. First upper strut leg 54″ includes first upper distal end 58″ and upper contour 102. Second upper strut leg 56″ includes second upper distal end 62″. Lower backer strut 38″ includes lower strut body 66″, first lower strut leg 68″, and second lower strut leg 70″. First lower strut leg 68″ includes first lower distal end 72″. Second lower strut leg 70″ includes second lower distal end 76″ and lower contour 104.

Interior skin 28″ is disposed on an interior-facing side of panel 12″, and exterior skin 30″ is disposed on an exterior-facing side of panel 12″. Interior skin 28″ and exterior skin 30″ define plenum 32 therebetween. Tongue 98 extends from upper edge 48″ of interior skin 28″. Groove 100 extends into lower edge 50″ of interior skin 28″. Tongue 98 is configured to mate with groove 100 of an adjacent panel 12″ when arranged into an overhead sectional door, such as overhead door 10 (FIG. 1A). As such, panel 12″ is configured to mate with an adjacent panel 12″ in a tongue and groove configuration. While upper edge 48″ is described as including tongue 98 and lower edge 50″ is described as including groove 100, it is understood that upper edge 48″ can include groove 100 and lower edge 50″ can include tongue 98. In such an example, upper backer strut 36″ is disposed proximate bottom leading edge 44 and lower backer strut 38″ is disposed proximate top leading edge 42.

Thermal breaks 40 are disposed at the interface of interior skin 28″ and exterior skin 30″. Thermal breaks 40 are made of a material having low thermal conductivity, such as an elastomer. Each thermal break 40 provides a barrier between interior skin 28″ and exterior skin 30″, which are typically formed from a thermally conductive material, such as a metal, to prevent thermal conduction through panel 12″.

Insulating material 34 is disposed within plenum 32 and insulates panel 12″ to reduce the thermal conductivity of panel 12″. Insulating material 34 can be any suitable material for thermally insulating panel 12″, such as liquid urethane or a polystyrene sheet. In some examples, interior skin 28″ and exterior skin 30″ are bonded to insulating material 34 by an adhesive.

Upper backer strut 36″ is disposed within plenum 32 proximate top leading edge 42 and on a side of vertical portion 46 of interior skin 28″ facing plenum 32. Upper backer strut 36″ is continuous and extends a full length L of panel 12″. Upper strut body 52″ abuts the side of interior skin 28″ facing plenum 32, and upper strut body 52″ provides an attachment structure for fastening various hardware to panel 12″, such as hinges 16 (FIGS. 1A-1C) and operator bracket 82 (FIGS. 1A-1B). The hardware is secured to panel 12″ by fasteners, such as fasteners 86 (FIGS. 1B-1C), extending through the hardware, through interior skin 28″, and through upper strut body 52″.

First upper strut leg 54″ extends from the top of upper strut body 52″ and into plenum 32 along upper edge 48″ of interior skin 28″. First upper strut leg 54″ extends from upper strut body 52″ at top leading edge 42 of panel 12″. As such, upper backer strut 36″ is positioned at top leading edge 42 and provides structural support to panel 12″ directly at top leading edge 42.

First upper distal end 58″ is disposed proximate thermal break 40. In some examples, first upper distal end 58″ extends to, but not beyond, thermal break 40. While first upper distal end 58″ is described as being disposed at thermal break 40, it is understood that first upper distal end 58″ can be disposed at any desired location along upper edge 48″ between vertical portion 46 of interior skin 28″ and thermal break 40. First upper distal end 58″ is spaced from exterior skin 30″, which prevents upper backer strut 36″ from providing a thermal conduction path through plenum 32.

Upper contour 102 extends from first upper strut leg 54″ between upper strut body 52″ and first upper distal end 58″. Upper contour 102 is a contoured portion of first upper strut leg 54″ configured to match the contour of upper edge 48″ of interior skin 28″. In the example shown, upper contour 102 extends into tongue 98 and has a contour configured to match the contour of tongue 98. Having first upper strut leg 54″ match the contour of upper edge 48″ provides additional structural support to panel 12″. While upper contour 102 is shown as a triangular projection and tongue 98 is shown as a triangular tongue, it is understood that upper contour 102 and tongue 98 can be of any desired configuration. For example, both upper contour 102 and tongue 98 can be trapezoidal, rectangular, irregularly-shaped, curved, or of any other desired configuration.

Second upper strut leg 56″ extends from the bottom of upper strut body 52″ and into plenum 32. Second upper strut leg 56″ extends between upper strut body 52″ and second upper distal end 62″. Second upper distal end 62″ is spaced from exterior skin 30″, which ensures that insulating material 34 is disposed between second upper distal end 62″ and exterior skin 30″ and prevents second upper strut leg 56″ from providing a conduction path through panel 12″. Gap 88 is disposed between first upper strut leg 54″ and second upper strut leg 56″, and gap 88 ensures that insulating material 34 can fill plenum 32 without leaving undesired voids within plenum 32 that are free of insulating material 34, particularly where insulating material 34 is applied as a liquid foam and cured-in-place.

Lower backer strut 38″ is disposed within plenum 32 proximate bottom leading edge 44 and on a side of vertical portion 46 of interior skin 28″ facing plenum 32. Lower strut body 66″ abuts the side of interior skin 28″ facing plenum 32 and is a continuous piece extending across a full length L of panel 12″. Lower strut body 66″ provides a structure for fastening various hardware to panel 12″, such as hinges 16 and operator bracket 82. The hardware is secured to panel 12″ by fasteners, such as fasteners 86, extending through the hardware, through interior skin 28″, and through lower strut body 66″.

First lower strut leg 68″ extends from the top of lower strut body 66″ and into plenum 32 along lower edge 50″ of interior skin 28″. First lower strut leg 68″ extends from the top of lower strut body 66″ and into plenum 32. First lower strut leg 68″ extends between lower strut body 66″ and first lower distal end 72″. First lower distal end 72″ is spaced from exterior skin 30″, which ensures that insulating material 34 is disposed between first lower distal end 72″ and exterior skin 30″ and prevents first lower strut leg 68″ from providing a conduction path through panel 12″.

Second lower strut leg 70″ extends between lower strut body 66″ and second lower distal end 76″. Second lower strut leg 70″ extends from lower strut body 66″ at bottom leading edge 44. As such, lower backer strut 38″ is positioned at bottom leading edge 44 and provides structural support to panel 12″ directly at bottom leading edge 44.

Second lower distal end 76″ is disposed proximate thermal break 40. In some examples, second lower distal end 76″ extends to, but not beyond, thermal break 40. While second lower distal end 76″ is described as being disposed at thermal break 40, it is understood that second lower distal end 76″ can be disposed at any desired location along lower edge 50″ between vertical portion 46 of interior skin 28″ and thermal break 40. Second lower distal end 76″ is spaced from exterior skin 30″, which prevents lower backer strut 38″ from providing a thermal conduction path through plenum 32.

Lower contour 104 extends from second lower strut leg 70″ between lower strut body 66″ and second lower distal end 76″. Lower contour 104 is a contoured portion of second lower strut leg 70″ configured to match the contour of lower edge 50″ of interior skin 28″. In the example shown, lower contour 104 extends into groove 100 and is contoured to match the contour of groove 100. Having second lower strut leg 70″ match the contour of lower edge 50″ provides additional structural support to panel 12″. While lower contour 104 is shown as a triangular projection and groove 100 is shown as a triangular groove, it is understood that lower contour 104 and groove 100 can be of any desired configuration. For example, both lower contour 104 and groove 100 can be trapezoidal, rectangular, irregularly-shaped, curved, or of any other desired configuration.

Upper backer strut 36″ and lower backer strut 38″ provide significant advantages. Upper backer strut 36″ and lower backer strut 38″ are continuous and extend across a full length L of panel 12″, which allows hardware to be fastened to panel 12″ at any desired location along the full length of panel 12″, thereby simplifying installation. First upper strut leg 54″ and second lower strut leg 70″ include upper contour 102 and lower contour 104, respectively, which are contoured to match the profiles of upper edge 48″ and lower edge 50″ of interior skin 28″, respectively. As such, first upper strut leg 54″ abuts upper edge 48″ across a full length of first upper strut leg 54″ and second lower strut leg 70″ abuts lower edge 50″ across a full length of second lower strut leg 70″, which provides increased structural support and stiffness to panel 12″.

Upper backer strut 36″ and lower backer strut 38″ are also embedded within panel 12″, which eliminates struts that are mounted on and project outwardly from vertical portion 46 of interior skin 28″ Eliminating the exterior struts provides a smooth, aesthetically pleasing look to interior skin 28″. Moreover, those exterior struts could not be mounted directly at top leading edge 42 and bottom leading edge 44 due to various other hardware, such as hinges, attached to panel 12″. Upper backer strut 36″ is disposed at top leading edge 42 and provides structural support at top leading edge 42, while lower backer strut 38″ is disposed at bottom leading edge 44 and provides structural support at bottom leading edge 44. Top leading edge 42 and bottom leading edge 44 experience significant stress as panel 12″ is raised and lowered during operation. Providing additional structural support directly at top leading edge 42 and bottom leading edge 44 reduces wear at the hinge point between adjacent panels 12″, thereby increasing the lifespan of panel 12″ Eliminating the exterior struts also simplifies installation of panel 12″, as the installer does not need to attach the exterior struts.

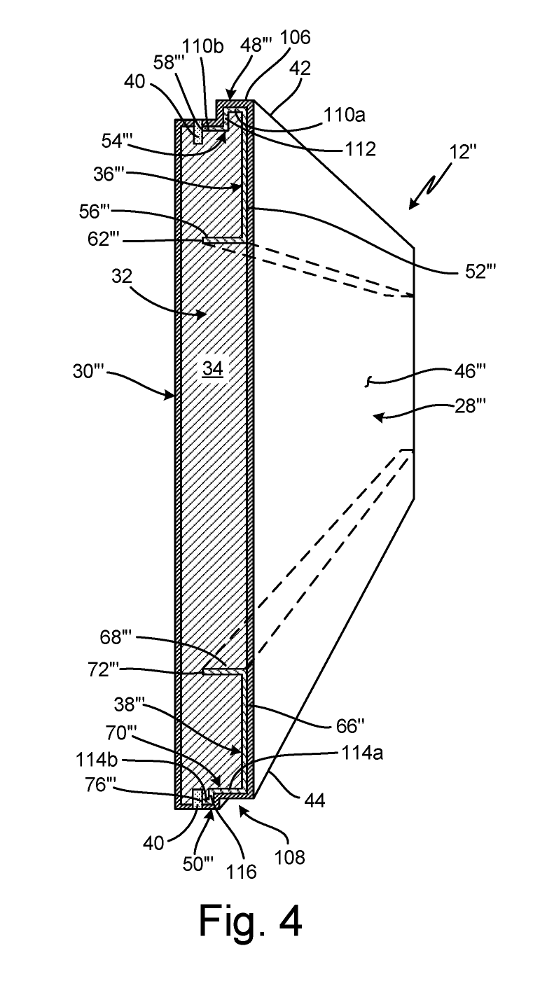

FIG. 4 is a cross-sectional, perspective view of panel 12′″. Panel 12′″ includes interior skin 28″, exterior skin 30′″, plenum 32, insulating material 34, upper backer strut 36″, lower backer strut 38″, thermal break 40, top leading edge 42, and bottom leading edge 44. Interior skin 28′″ includes vertical portion 46″, upper edge 48″, and lower edge 50′″. Upper edge 48′″ includes tab 106, and lower edge 50′″ includes recess 108. Upper backer strut 36′″ includes upper strut body 52′″, first upper strut leg 54′″, and second upper strut leg 56′″. First upper strut leg 54′″ includes first upper distal end 58′″, upper horizontal portions 110a-110b, and upper intermediate portion 112. Second upper strut leg 56′″ includes second upper distal end 62′″. Lower backer strut 38′″ includes lower strut body 66″, first lower strut leg 68″, and second lower strut leg 70′″. First lower strut leg 68′″ includes first lower distal end 72′″. Second lower strut leg 70′″ includes second lower distal end 76″, lower horizontal portions 114a-114b, lower intermediate portion 116.

Panel 12′″ is similar to panel 12″ (FIG. 3), except that upper edge 48′″ includes tab 106 instead of tongue 98 and lower edge 50′″ includes recess 108 instead of groove 100. In addition, the profiles of first upper strut leg 54′″ and second lower strut leg 70′″ are contoured to match the profiles of upper edge 48′″ and lower edge 50′″ of interior skin 28′″.

Interior skin 28′″ is disposed on an interior-facing side of panel 12′″, and exterior skin 30′″ is disposed on an exterior-facing side of panel 12′″. Interior skin 28′″ and exterior skin 30′″ define plenum 32 therebetween. Tab 106 extends from upper edge 48′″ of interior skin 28′″ and is located at top leading edge 42 of panel 12′″. Recess 108 extends into lower edge 50′″ of interior skin 28′″ and is located at bottom leading edge 44 of panel 12′″. Tab 106 of panel 12′″ is configured to mate with recess 108 of an adjacent panel 12′″ when arranged into an overhead sectional door, such as overhead door 10 (FIG. 1A). As such, panel 12′″ is configured to mate with an adjacent panel 12′″ in a shiplap configuration. Thermal break 40 is disposed at the interface of interior skin 28′″ and exterior skin 30′″. Insulating material 34 is disposed within plenum 32 and insulates panel 12′″ to reduce the thermal conductivity of panel 12′″. While upper edge 48′″ is described as including tab 106 and lower edge 50′″ is described as including recess 108, it is understood that upper edge 48′″ can include recess 108 and lower edge 50′″ can include tab 106. In such an example, upper backer strut 36′″ is disposed proximate bottom leading edge 44 and lower backer strut 38′″ is disposed proximate top leading edge 42.

In the example shown, upper backer strut 36′″ is disposed within plenum 32 proximate top leading edge 42 and on a side of vertical portion 46′″ of interior skin 28′″ facing plenum 32. Upper backer strut 36′″ is a continuous piece that extends across a full length L of panel 12′″. Upper strut body 52′″ abuts the side of interior skin 28′″ facing plenum 32 and provides an attachment structure for fastening various hardware to panel 12′″, such as hinges 16 (FIGS. 1A-1C) and operator bracket 82 (FIGS. 1A-1B). The hardware is secured to panel 12′″ by fasteners, such as fasteners 86 (FIGS. 1B-1C), extending through the hardware, vertical portion 46″, and upper strut body 52′″.

First upper strut leg 54′″ extends from the top of upper strut body 52′″ and into plenum 32 along upper edge 48′″ of interior skin 28′″. Upper horizontal portion 110a extends from the top of upper strut body 52′″ to upper intermediate portion 112′″. Upper horizontal portion 110a extends across a full width of tab 106. Upper horizontal portion 110b extends from upper intermediate portion 112′″ to first upper distal end 58′″. Upper intermediate portion 112′″ extends between and connects upper horizontal portion 110a and upper horizontal portion 110b. Upper intermediate portion 112′″ has a height similar to tab 106, such that both upper horizontal portion 110a and upper horizontal portion 110b abut upper edge 48′″ of interior skin 28′″. First upper distal end 58′″ is disposed proximate thermal break 40. In some examples, first upper distal end 58′″ extends to, but not beyond, thermal break 40. While first upper distal end 58′″ is described as being disposed at thermal break 40, it is understood that first upper distal end 58′″ can be disposed at any desired location along upper edge 48′″ between vertical portion 46′″ of interior skin 28′″ and thermal break 40. First upper distal end 58′″ is spaced from exterior skin 30′″, which prevents upper backer strut 36′″ from providing a thermal conduction path through plenum 32.

Upper horizontal portion 110a, upper horizontal portion 110b, and vertical portion 46′″ provide a contour to first upper strut leg 54′″ that matches the contour of upper edge 48′″ and tab 106 of interior skin 28′″. The contouring ensures that upper strut body 52′″ extends to and abuts top leading edge 42 of interior skin 28″, thereby providing structural support to panel 12′″ at top leading edge 42.

Second upper strut leg 56′″ extends from the bottom of upper strut body 52′″ and into plenum 32. Second upper strut leg 56′″ extends between upper strut body 52′″ and second upper distal end 62′″. Second upper distal end 62′″ is spaced from exterior skin 30′″, which ensures that insulating material 34 is disposed between second upper distal end 62′″ and exterior skin 30′″ and prevents second upper strut leg 56′″ from providing a conduction path through panel 12′″.

Gap 88 is disposed between first upper distal end 58′″ and second upper distal end 62″, such that upper backer strut 36′″ is open to plenum 32. In some examples, insulating material 34 is applied to plenum 32 as a liquid that is then cured-in-place. Gap 88 ensures that insulating material 34 can fill plenum 32, without leaving voids within plenum 32 that are free of thermal insulation.

In the example shown, lower backer strut 38′″ is disposed within plenum 32 proximate bottom leading edge 44 and on a side of vertical portion 46′″ of interior skin 28′″ facing plenum 32. Lower backer strut 38′″ is a continuous piece that extends across a full length L of panel 12′″. Lower strut body 66′″ abuts the side of interior skin 28′″ facing plenum 32 and provides a structure for fastening various hardware to panel 12′″, such as hinges 16 and operator bracket 82. The hardware is secured to panel 12′″ by fasteners extending through the hardware, vertical portion 46″, and lower strut body 66′″.

First lower strut leg 68′″ extends from the top of lower strut body 66′″ and into plenum 32. First lower strut leg 68′″ extends between lower strut body 66′″ and first lower distal end 72′″. First lower distal end 72′″ is spaced from exterior skin 30′″, which ensures that insulating material 34 is disposed between first lower distal end 72′″ and exterior skin 30′″ and prevents first lower strut leg 68′″ from providing a conduction path through panel 12′″.

Second lower strut leg 70′″ extends from the bottom of lower strut body 66′″ and into plenum 32 along lower edge 50′″ of interior skin 28′″. Lower horizontal portion 114a extends from the bottom of lower strut body 66′″ to lower intermediate portion 116. Lower horizontal portion 114a extends across a full width of the top of recess 108. Lower horizontal portion 114b extends from lower intermediate portion 116 to second lower distal end 76′″. Lower intermediate portion 116 extends between and connects lower horizontal portion 114a and lower horizontal portion 114b. Lower intermediate portion 116 has a height similar to recess 108, such that both lower horizontal portion 114a and lower horizontal portion 114b abut lower edge 50′″ of interior skin 28′″. Second lower distal end 76′″ is disposed proximate thermal break 40. In some examples, second lower distal end 76′″ extends to, but not beyond, thermal break 40. While second lower distal end 76′″ is described as being disposed at thermal break 40, it is understood that second lower distal end 76′″ can be disposed at any desired location along lower edge 50′″ between vertical portion 46′″ of interior skin 28′″ and thermal break 40. Second lower distal end 76′″ is spaced from exterior skin 30′″, which prevents lower backer strut 38′″ from providing a thermal conduction path through plenum 32.

Lower horizontal portion 114a, lower horizontal portion 114b, and lower intermediate portion 116 provide a contour to second lower strut leg 70′″ that matches the contour of lower edge 50′″ and recess 108 of interior skin 28′″. The contouring ensures that lower strut body 66′″ extends to and abuts bottom leading edge 44 of interior skin 28″, thereby providing structural support to panel 12′″ at bottom leading edge 44. Gap 88 is disposed between first lower distal end 72′″ and second lower distal end 76″, such that lower backer strut 38′″ is open to plenum 32. In some examples, insulating material 34 is applied to plenum 32 as a liquid that is then cured-in-place. Gap 88 ensures that insulating material 34 can fill plenum 32, without leaving voids within plenum 32 that are free of thermal insulation.

Upper backer strut 36′″ and lower backer strut 38′″ provide significant advantages. Upper backer strut 36′″ and lower backer strut 38′″ are continuous and extend across a full width of panel 12′″, which allows hardware to be fastened to panel 12′″ at any desired location along the full width of panel 12′″, thereby simplifying installation. First upper strut leg 54′″ and second lower strut leg 70′″ are contoured to match the profiles of upper edge 48′″ and lower edge 50′″ of interior skin 28″, respectively. As such, first upper strut leg 54′″ abuts upper edge 48′″ across a full length of first upper strut leg 54′″ and second lower strut leg 70′″ abuts lower edge 50′″ across a full length of second lower strut leg 70′″, which provides increased structural support and stiffness to panel 12′″.

Upper backer strut 36′″ and lower backer strut 38′″ are also embedded within panel 12′″, which eliminates struts that are mounted on and project outwardly from vertical portion 46′″ of interior skin 28′″ Eliminating the exterior struts provides a smooth, aesthetically pleasing look to interior skin 28′″. Moreover, those exterior struts could not be mounted directly at top leading edge 42 and bottom leading edge 44 due to various other hardware, such as hinges, attached to panel 12′″. Upper backer strut 36′″ and is disposed at top leading edge 42 and provides structural support at top leading edge 42, while lower backer strut 38′″ is disposed at bottom leading edge 44 and provides structural support at bottom leading edge 44. Top leading edge 42 and bottom leading edge 44 experience significant stress during as panel 12′″ is raised and lowered during operation. Providing additional structural support directly at top leading edge 42 and bottom leading edge 44 reduces wear at the hinge point between adjacent panels 12′″, thereby increasing the lifespan of panel 12′″ Eliminating the exterior struts also simplifies installation of panel 12′″, as the installer does not need to attach the exterior struts.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A panel for an overhead door, the panel comprising:
an exterior skin;
an interior skin having a vertical portion, a top portion extending from a top leading edge of the vertical portion, and a bottom portion extending from a bottom leading edge of the vertical portion, wherein the interior skin is spaced from the exterior skin to define a plenum therebetween;
an upper backer strut disposed within the plenum proximate the top leading edge and extending across a length of the panel, the upper backer strut comprising:
an upper strut body at least partially abutting a side of the vertical portion of the interior skin facing the plenum;
a first upper strut leg extending from the upper strut body and having a first upper distal end spaced from the exterior skin; and
a second upper strut leg extending from the upper strut body and having a second upper distal end spaced from the exterior skin;
a lower backer strut disposed within the plenum proximate the bottom leading edge and extending across the length of the panel, the lower backer strut comprising:
a lower strut body at least partially abutting the side of the vertical portion of the interior skin facing the plenum;
a first lower strut leg extending from the lower strut body and having a first lower distal end spaced from the exterior skin; and
a second lower strut leg extending from the lower strut body and having a second lower distal end spaced from the exterior skin.

2. The panel of claim 1, further comprising an insulating material disposed within the plenum.

3. The panel of claim 2, further comprising:
a thermal break disposed between and separating the top portion of the interior skin and the exterior skin;
wherein the first upper strut leg extends to the thermal break.

4. The panel of claim 2, further comprising:
a thermal break disposed between and separating the bottom portion of the interior skin and the exterior skin;
wherein the second lower strut leg extends to the thermal break.

5. The panel of claim 1, wherein the first upper strut leg abuts the top portion.

6. The panel of claim 1, wherein:
the top portion includes a first projection;
the first upper strut leg includes a first contour between the upper strut body and the first upper distal end, the first contour matching a profile of the first projection such that the first upper strut leg abuts the top portion at the first projection;
the bottom portion includes a second projection; and
the second lower strut leg includes a second contour between the lower strut body and the second lower distal end, the second contour matching a profile of the second projection such that the second lower strut leg abuts the lower portion at the second projection.

7. The panel of claim 6, wherein the first projection comprises a tongue and the second projection comprises a groove.

8. The panel of claim 6, wherein the first projection comprises a tab disposed at the top leading edge and the second projection comprises a recess disposed at the bottom leading edge.

9. The panel of claim 1, wherein the first upper distal end includes a first flange extending away from the top portion, and the second upper distal end includes a second flange extending towards the top portion.

10. An overhead sectional door comprising:
a plurality of panels, wherein each one of the plurality of panels comprises:
an exterior skin;
an interior skin having a vertical portion, a top portion extending from a top leading edge of the vertical portion, and a bottom portion extending from a bottom leading edge of the vertical portion, wherein the interior skin is spaced from the exterior skin such to define a plenum therebetween;
an upper backer strut disposed within the plenum proximate the top leading edge and extending across a length of the panel, the upper backer strut comprising:
an upper strut body at least partially abutting a side of the vertical portion of the interior skin facing the plenum;
a first upper strut leg extending from the upper strut body and having a first upper distal end spaced from the exterior skin; and
a second upper strut leg extending from the upper strut body and having a second upper distal end spaced from the exterior skin;
a lower backer strut disposed within the plenum proximate the bottom leading edge and extending across the length of the panel, the lower backer strut comprising:
a lower strut body at least partially abutting the side of the vertical portion of the interior skin facing the plenum;
a first lower strut leg extending from the lower strut body and having a first lower distal end spaced from the exterior skin; and
a second lower strut leg extending from the lower strut body and having a second lower distal end spaced from the exterior skin;
a plurality of hinges connecting adjacent ones of the plurality of panels, wherein the plurality of hinges are disposed on the vertical portion of the interior skin and are connected to the upper backer strut and the lower backer strut.

11. The overhead door assembly of claim 10, further comprising:
an operator bracket mounted on a top panel of the plurality of panels, wherein the operator bracket is fastened to the upper backer strut of the top panel and the lower backer strut of the top panel.

12. The overhead door assembly of claim 10, wherein each one of the plurality of panels further comprises an insulating material disposed within the plenum.

13. The overhead door assembly of claim 12, wherein each one of the plurality of panels further comprises:
a thermal break disposed between and separating the top portion of the interior skin and the exterior skin; and
wherein the first upper strut leg extends to the thermal break.

14. The overhead door assembly of claim 12, wherein each one of the plurality of panels further comprises:
a thermal break disposed between and separating the bottom portion of the interior skin and the exterior skin; and
wherein the second lower strut leg extends to the thermal break.

15. The overhead door assembly of claim 10, wherein for each one of the plurality of panels:
the top portion includes a first projection;
the first upper strut leg includes a first contour between the upper strut body and the first upper distal end, the first contour matching a profile of the first projection such that the first upper strut leg abuts the top portion at the first projection;
the bottom portion includes a second projection;
the second lower strut leg includes a second contour between the lower strut body and the second lower distal end, the second contour matching a profile of the second projection such that the second lower strut leg abuts the lower portion at the second projection; and
the first projection on a first one of the plurality of panels is configured to mate with the second projection on a second one of the plurality panels.

16. The overhead door assembly of claim 15, wherein the first projection comprises a tongue and the second projection comprises a groove.

17. The overhead door assembly of claim 15, wherein the first projection comprises a tab disposed at the top leading edge and the second projection comprises a recess disposed at the bottom leading edge.

18. The overhead door assembly of claim 10, wherein the first upper distal end includes a first flange extending away from the top portion, and the second upper distal end includes a second flange extending towards the top portion.

19. A reinforcing and hardware attachment assembly for an overhead sectional door panel, the assembly comprising:
an upper backer strut disposed within the overhead sectional door panel proximate a top leading edge on an interior side of a skin of the overhead sectional door panel, the upper backer strut comprising:
an upper strut body abutting the interior side of the overhead sectional door panel;
a first upper strut leg extending from the upper strut body and having a first upper distal end spaced from an exterior side of the overhead sectional door panel; and
a second upper strut leg extending from the upper strut body and having a second upper distal end spaced from the exterior side of the overhead sectional door panel;
a lower backer strut disposed within the plenum proximate a bottom leading edge on the interior side of the skin of the overhead sectional door panel, the lower backer strut comprising:
a lower strut body abutting the interior side of the overhead sectional door panel;
a first lower strut leg extending from the lower strut body and having a first lower distal end spaced from the exterior side of the overhead sectional door panel; and
a second lower strut leg extending from the lower strut body and having a second lower distal end spaced from the exterior side of the overhead sectional door panel;
wherein the upper backer strut and the lower backer strut extend across a full length of the overhead sectional door panel, and wherein the upper strut body is configured to receive one or more fasteners extending through the interior side of the overhead sectional door panel and the lower strut body is configured to receive one or more fasteners extending through the skin of the body.

20. The assembly of claim 19, wherein the first upper strut leg is contoured to match a profile of a top portion of the overhead sectional door panel, such that the first upper strut leg abuts the top portion, and the second lower strut leg is contoured to match the profile of a bottom portion of the overhead sectional door panel, such that the second lower strut leg abuts the bottom portion.
